(19) United States
(12) Patent Application Publication
(10) Pub. No.: US 2026/0099833 A1
(43) Pub. Date: Apr. 9, 2026

(54) PAYMENT CARD REPLACEMENT DEVICE

(71) Applicant: Wells Fargo Bank, N.A., San Francisco, CA (US)

(72) Inventor: Ryan Michael Hegland, Lakeville, MN (US)

(21) Appl. No.: 18/906,862

(22) Filed: Oct. 4, 2024

(51) Int. Cl. G06Q 20/34; G06K 19/06; G06Q 20/36

(52) U.S. Cl. CPC G06Q 20/354; G06K 19/06037; G06Q 20/363

(57) ABSTRACT

Instant payment card replacement involves a computing device receiving a request to replace a user's payment card. The device receives and verifies identity information from a mobile wallet of the user. Upon verification, the device provisions and provides a physical payment card. The method may also include provisioning a digital payment method to the mobile wallet. Identity information can be received via Radio Frequency Identification or by scanning an encoded image, such as a QR code. The physical card can be printed from a blank card or an unallocated pre-printed card may be provided.

### TECHNICAL FIELD

Embodiments pertain to secure identity verification and card issuance systems. Some embodiments relate to methods and devices for instant payment card replacement using mobile digital identity credentials.

### BACKGROUND

Users experiencing a fraud event, loss, or theft of a bank card often face significant delays in obtaining a replacement card. The traditional process involves multiple steps, including contacting the bank, verifying identity through various means, and waiting for the card to be mailed. This process can be particularly inconvenient for users who are traveling or in need of a replacement card. The current method is not only time-consuming but also stressful for users who are left without access to their funds during this period.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a system for using an identity element of a mobile wallet to identify a user to a card replacement device for obtaining a physical replacement card, according to some examples of the present disclosure.

FIG. 2 illustrates a system for payment card replacement using a card replacement device and a user device with a mobile wallet, according to some examples of the present disclosure.

FIG. 3 shows a flowchart of a method for replacing a payment card at a card replacement device, according to some examples of the present disclosure.

FIG. 4 illustrates a block diagram of an example machine upon which one or more embodiments may be implemented, according to some examples of the present disclosure.

### DETAILED DESCRIPTION

Disclosed in some examples are methods, systems, devices, and machine-readable media that facilitate card or document replacement, such as instant card replacement using Mobile Driver's License (mDL) technology integrated into very smart mobile wallets (VSW). The system utilizes card replacement devices, for example computing devices in the form of self-serve kiosks or ATMs that can provision a new card to the customer upon verification of their identity using the mDL. The kiosk or other device may print or otherwise create the card for the user's account information using pre-printed cards or card blanks. This process is initiated only after the user verifies their identity using the mDL stored in their VSW. Additionally, and in some examples, the kiosk can provision a new mobile payment method simultaneously, further enhancing the convenience for the user. This functionality can be integrated into existing ATMs or dedicated kiosks and is not limited to payment cards as it can be extended to various types of cards and documents, such as passports or benefit cards.

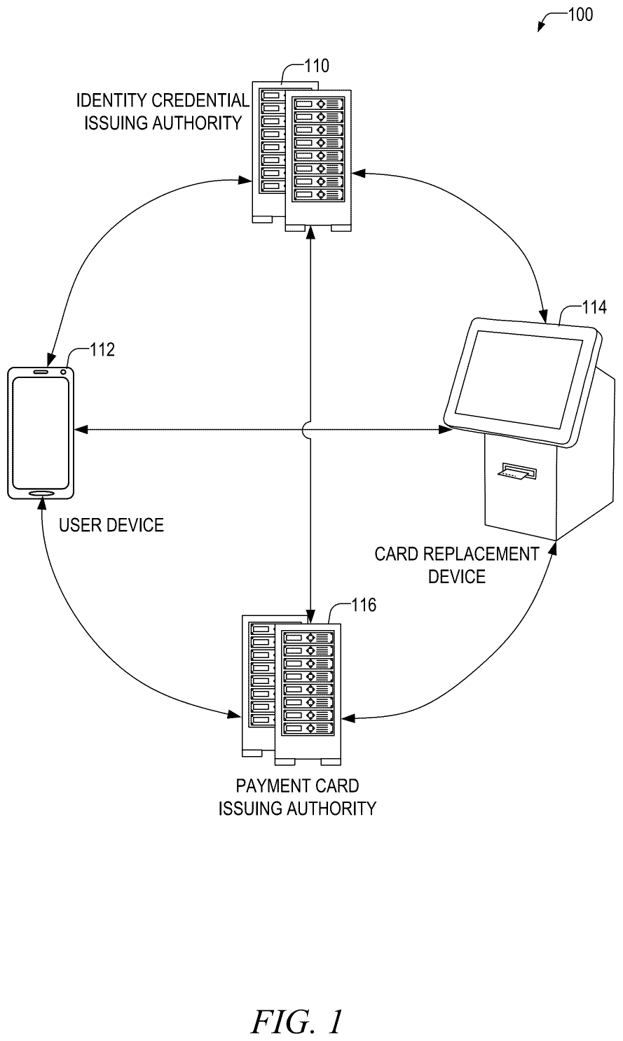

FIG. 1 shows a system 100 of using an identity element of a user device 112 to identify a user to a card replacement device 114 to obtain a physical replacement card according to some examples of the present disclosure. The system 100 includes an identity credential issuing authority 110, a user device 112, a card replacement device 114, and a payment card issuing authority 116. The identity element may be part of a user's mobile wallet.

The identity credential issuing authority 110 issues and manages identity credentials, such as a Mobile Driver's License (mDL), to users such as the user of user device 112. The mDL is stored in a mobile wallet of the user device 112. When the user of the user device 112 needs a replacement payment card, such as a credit card, debit card, or other card, the user device 112 may contact the payment card issuing authority 116. The user device 112 may contact the payment card issuing authority 116 using a dedicated application (such as a banking application), through a telephone contact, through a website of the payment card issuing authority 116, or via the card replacement device 114. The payment card issuing authority 116 may then cancel the previous payment card and indicate in account information of the user that the user requested a new payment card.

The payment card issuing authority 116 may provide a list of card replacement options, such as allowing the user to receive a new card in the mail or through a card replacement device, such as card replacement device 114. The payment card issuing authority 116 may provide a list of nearby card replacement devices 114 for the user to visit that is based upon a current geolocation of the user. The geolocation of the user may be received from a Global Positioning System (GPS) device on the user device 112, self-reported by the user, or the like.

The card replacement device 114 may be a special purpose kiosk or may be part of an ATM. The card replacement device 114 is configured to receive identity information from the user device 112. In some examples, this includes utilizing near-field communication technologies to receive the mDL information. In other examples, this may include the card replacement device 114 scanning an image displayed on the user device 112 that is encoded with the mDL or information from the mDL. For example, scanning a QR or bar code. This identity information is verified by the card replacement device 114 using the cryptographic signature contained within the mDL. For example, by utilizing a public key of the identity credential issuing authority 110 to verify the signature of the mDL. Upon successful verification, the card replacement device 114 communicates with the payment card issuing authority 116 to provision a new physical payment card for the user. The payment card issuing authority 116 manages the issuance and activation of payment cards, ensuring that the new card is linked to the user's account and ready for use.

The card replacement device 114 then prints a new card for the user from blank cards or, uses a pre-printed but not assigned card and issues it to the user e.g., by communicating the number of the pre-printed but not assigned card to the payment card issuing authority 116. In the latter example, the payment card issuing authority 116 may then associate the number of the card with the user's account. The new card is then conveniently provided to the user.

In some examples, instead of the verification happening at the card replacement device 114, the mDL information is transmitted by the card replacement device 114 to the payment card issuing authority 116 which may verify the mDL information. In some examples, the identity credential issuing authority may communicate with the payment card issuing authority and/or the card replacement device 114. For example, to provide its public key.

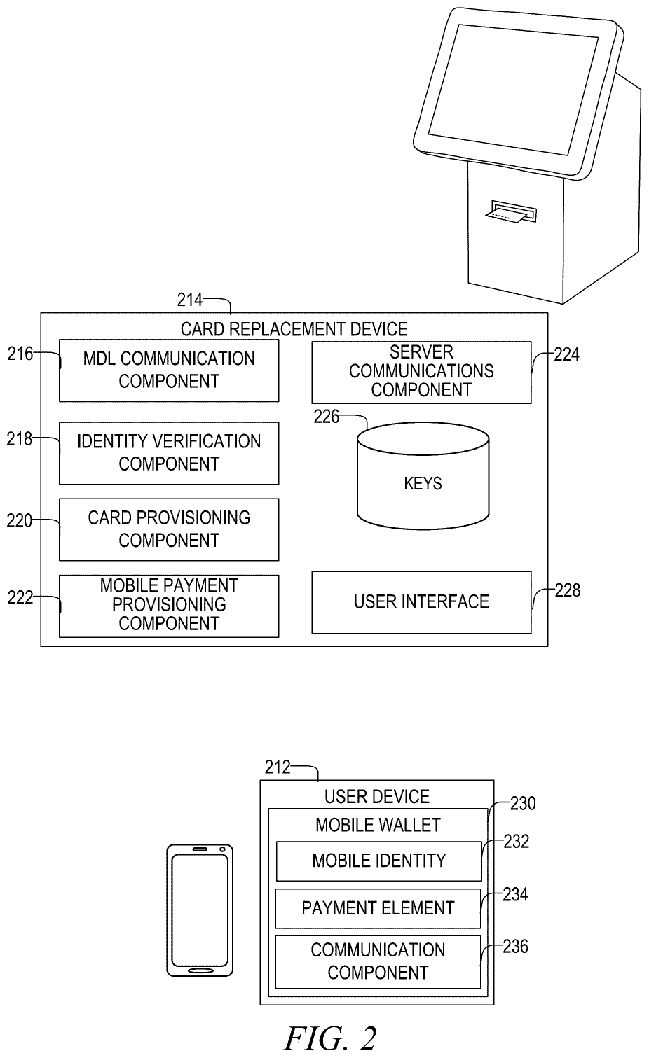

FIG. 2 illustrates a system for payment card replacement according to some examples of the present disclosure. The user begins by interacting with the user interface on the card replacement device 214, which is provided by user interface component 228, which provides the user prompts to guide them through the steps necessary to obtain a new card. In some examples, the card replacement device 214 prompts the user to log into their account, but in other examples, the authentication may be done using the mDL. As part of the card replacement process, the user interface component 228 prompts the user to provide their mDL information. The card replacement device 214 includes an mDL communication component 216 that receives the identity information from the user device 212.

The user device 212, which contains a mobile wallet 230 with a mobile identity 232, communicates the mobile identity information to the card replacement device 214 using the communication component 236. The identity information may be communicated through the mDL communication component 216 scanning an image displayed by a screen of the user device 212 (e.g., a QR or bar code), communicating with the user device 212 using radio frequency technologies such as RFID, Bluetooth, WIFI, or other short range wireless communications technologies (e.g., having a typical usable range of 100 meters or less), or the like.

Once the identity information is received, the identity verification component 218 in the card replacement device 214 verifies the received identity information. This component uses cryptographic signatures contained within the mobile identity 232 and verifies them using public identifiers (e.g., public keys) stored in the key storage 226. For example, a public key of an identity credential issuing authority. This ensures the authenticity of the identity information. The identity information may then be used to access an account of the user.

In some examples, the card replacement device 214 may have one or more cameras which may be used to verify the identity of the user instead of, or in addition to, using the digital identity (e.g., mDL). For example, utilizing facial recognition technologies. In examples in which both facial recognition and the mDL are utilized, both must match for the user to be authenticated.

Upon successful identity verification, and upon verifying that the payment card issuing authority has authorized a new card, the card provisioning component 220 in the card replacement device 214 provisions a new physical payment card for the user. The card provisioning component 220 communicates with the payment card issuing authority via the server communications component 224 to issue a new card linked to the user's account. The new card may then be printed and dispensed to the user through the card replacement device 214. In other examples, the card replacement device may have pre-printed cards with unassigned numbers. The card replacement device 214 may then send a number of one of the cards with unassigned numbers to the payment card issuing authority to link the number to the user's card and to activate the card for payments. The server communications component 224 in the card replacement device 214 manages communication with external servers, such as the payment card issuing authority and the identity credential issuing authority. This component ensures that the new card is activated and linked to the user's account, facilitating seamless card replacement.

Additionally, the mobile payment provisioning component 222 in the card replacement device 214 can provision a new mobile payment method to the mobile wallet 230 of the user device 212. This allows the user to immediately use the new payment method on their user device 212, enhancing convenience. The mobile payment provisioning may happen using the mDL communication component 216—e.g., wirelessly.

The keys storage 226 in the card replacement device 214 securely stores cryptographic data used for verifying the identity information. These data are required for the identity verification component 218 to authenticate the mobile identity 232 received from the user device 212.

In some examples, the card replacement device 214 may replace payment cards that have been previously reported as lost or stolen. In these scenarios, the card replacement device 214 first verifies the status of the user's account by communicating with the payment card issuing authority to confirm that the account has been flagged for a lost or stolen card. This ensures that only authorized replacements are processed.

In other examples, the card replacement device 214 also allows users to report a lost or stolen card and obtain a replacement in a single session. In these cases, the user begins by interacting with the user interface on the card replacement device 214, which guides them through the process of reporting the lost or stolen card. The device then verifies the user's identity, either by checking the identity information on the mobile driver's license (mDL) stored in the mobile wallet 230 or by requiring the user to enter their username and password. Once the user's identity is verified, the card replacement device 214 communicates with the payment card issuing authority to update the account status, marking the card as lost or stolen. Subsequently, the card replacement device 214 proceeds to issue a new card. This streamlined process not only enhances user convenience but also ensures that the replacement card is securely linked to the user's account and ready for immediate use. The user device 212 includes a mobile wallet 230 that stores the mobile identity 232 and the payment element 234. The mobile identity 232 contains the user's identity credentials, such as a mobile driver's license (mDL). The payment element 234 includes payment information, such as credit or debit card details, used for transactions.

The communication component 236 in the user device 212 facilitates communication with the card replacement device 214. This component ensures that the mobile identity 232 and other necessary information are transmitted securely to the card replacement device 214 for processing. As previously noted, this may include displaying an image, communicating using radio frequency communications, or the like.

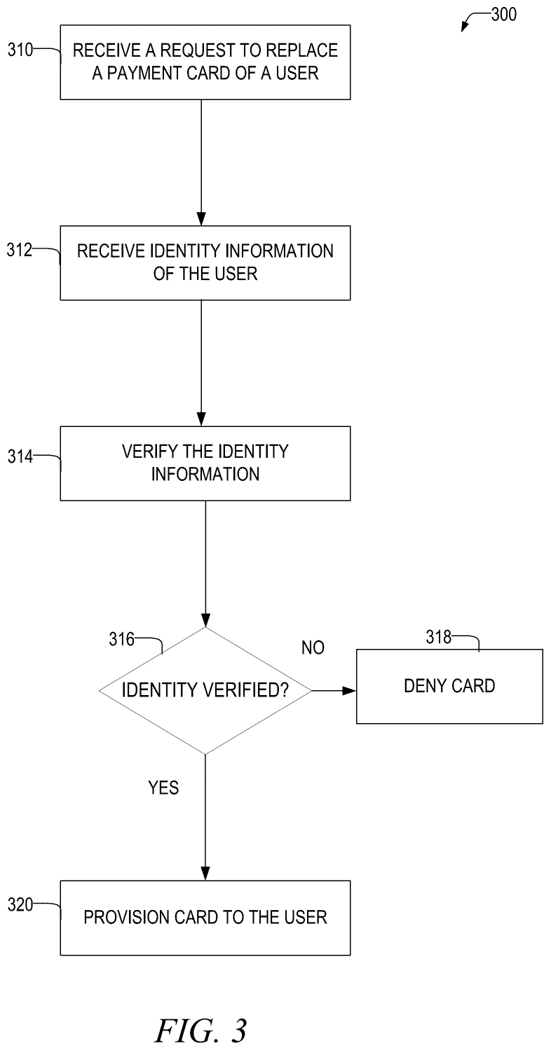

FIG. 3 shows a flowchart of a method 300 of replacing a payment card at a card replacement device. The method 300 begins at operation 310 with receiving a request to replace a payment card of a user. This step involves the user initiating a request at the card replacement device to replace their existing payment card, which may be lost, stolen, or otherwise compromised.

At operation 312, the card replacement device receives the user's identity information, which is stored in an identity element within a mobile wallet on the user's device. The identity information may include a Mobile Driver's License (mDL) or other digital identity credentials. The card replacement device can receive this information through various communication technologies, such as near-field communication (NFC), Bluetooth, or by scanning an encoded image (e.g., a QR code) displayed on the user's device.

Following the receipt of the identity information, the method proceeds to operation 314, where the card replacement device verifies the received identity information based on a cryptographic signature contained within the identity information. This verification process involves using public keys stored in the card replacement device to authenticate the cryptographic signature, ensuring that the identity information is genuine and corresponds to the user requesting the card replacement.

At operation 316, the system determines whether the identity information is verified. If the identity information is not verified, the method proceeds to operation 318, where the card replacement device denies the card replacement request due to the failure to verify the user's identity. This may involve displaying an error message to the user and logging the failed attempt for security purposes. This process may also involve ensuring that a user's account information is valid and that a replacement card is indicated for the user.

If the identity information is verified, the method proceeds to operation 320, where the card replacement device provisions a new physical payment card to the user. The card replacement device may print a new card from a blank card using an integrated card printer or allocate a pre-stored payment card to the user's account by communicating with the payment card issuing authority. The new card is then activated and linked to the user's account, ensuring it is ready for immediate use. The card replacement device then dispenses the new card to the user, completing the card replacement process.

While the present application discloses techniques for replacing payment cards, the devices, systems, and methods disclosed herein could be used to replace other items such as passports, driver's licenses, library cards, and other documents.

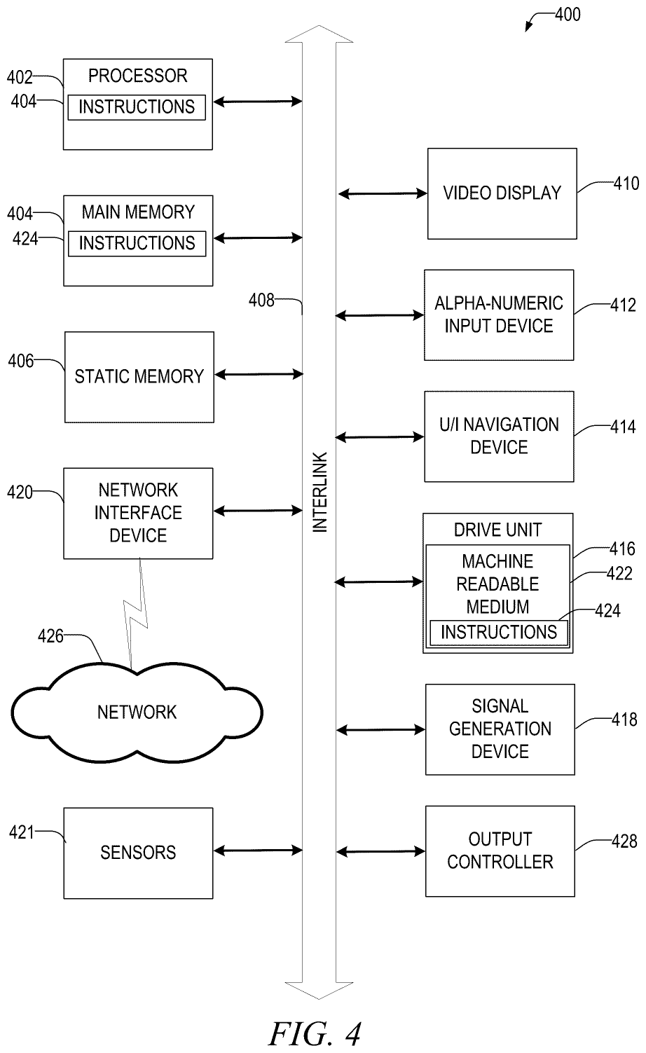

FIG. 4 illustrates a block diagram of an example machine 400 upon which any one or more of the techniques (e.g., methodologies) discussed herein may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a card replacement device (e.g., such as card replacement device 114, 214),, desktop computer, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The machine 400 may be configured to be a card replacement device (114, 214), user device (112, 212), and perform the methods of FIG. 3.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5. Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over a communications network 426 using a transmission medium via the network interface device 420. The Machine 400 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

1. A method for instant payment card replacement, the method comprising:
at a computing device:
receiving a request to replace a payment card of a user, receiving identity information of the user from an identity element in a mobile wallet of a device of the user;
verifying the identity information of the user based upon a cryptographic signature in the identity information;
responsive to verifying the identity information of the user, provisioning a physical payment card to the user; and
dispensing the physical payment card to the user.

2. The method of claim 1, further comprising, provisioning a digital payment method to a mobile wallet of the user.

3. The method of claim 1, wherein receiving the identity information of the user comprises receiving the identity information using Radio Frequency Identification.

4. The method of claim 1, wherein receiving the identity information of the user comprises scanning an encoded image.

5. The method of claim 4, wherein the encoded image is a Quick Response (QR) code.

6. The method of claim 1, wherein provisioning the physical payment card comprises printing a physical payment card from a blank card.

7. The method of claim 1, wherein provisioning the physical payment card comprises allocating a stored payment card to an account of the user.

8. A computing device, for instant payment card replacement, the computing device comprising:
a hardware processor;
a memory, the memory storing instructions, which when executed by the hardware processor cause the computing device to perform operations comprising:
receiving a request to replace a payment card of a user;
receiving identity information of the user from an identity element in a mobile wallet of a device of the user;
verifying the identity information of the user based upon a cryptographic signature in the identity information;
responsive to verifying the identity information of the user, provisioning a physical payment card to the user; and
dispensing the physical payment card to the user.

9. The computing device of claim 8, wherein the operations further comprise provisioning a digital payment method to a mobile wallet of the user.

10. The computing device of claim 8, wherein the operation of receiving the identity information of the user further comprises receiving the identity information using Radio Frequency Identification.

11. The computing device of claim 8, wherein the operation of receiving the identity information of the user further comprises scanning an encoded image.

12. The computing device of claim 11, wherein the encoded image is a Quick Response (QR) code.

13. The computing device of claim 8, wherein the operation of provisioning the physical payment card further comprises printing a physical payment card from a blank card.

14. The computing device of claim 8, wherein the operation of provisioning the physical payment card further comprises allocating a stored payment card to an account of the user.

15. A non-transitory machine-readable medium, storing instructions for instant payment card replacement, the instructions, which when executed, cause a machine to perform operations comprising:
receiving a request to replace a payment card of a user;
receiving identity information of the user from an identity element in a mobile wallet of a device of the user;
verifying the identity information of the user based upon a cryptographic signature in the identity information;
responsive to verifying the identity information of the user, provisioning a physical payment card to the user; and
dispensing the physical payment card to the user.

16. The non-transitory machine-readable medium of claim 15, wherein the operations further comprise provisioning a digital payment method to a mobile wallet of the user.

17. The non-transitory machine-readable medium of claim 15, wherein the operation of receiving the identity information of the user further comprises receiving the identity information using Radio Frequency Identification.

18. The non-transitory machine-readable medium of claim 15, wherein the operation of receiving the identity information of the user further comprises scanning an encoded image.

19. The machine-readable medium of claim 18, wherein the encoded image is a Quick Response (QR) code.

20. The non-transitory machine-readable medium of claim 15, wherein the operation of provisioning the physical payment card further comprises printing a physical payment card from a blank card.
